(19) United States
(12) Patent Application Publication
(10) Pub. No.: US 2004/0109224 A1
(43) Pub. Date: Jun. 10, 2004

(54) Reflective dispersion-compensation optical amplifier

(76) Inventors: Sung-Tae Kim, Suwon-shi (KR); Seong-Taek Hwang, Pyongtaek-shi (KR)

Correspondence Address: CHA & REITER, LLC, 210 ROUTE 4 EAST STE 103, PARAMUS, NJ, 07652, US

(21) Appl. No.: 10/458,152

(22) Filed: Jun. 10, 2003

(30) Foreign Application Priority Data
Dec. 9, 2002 (KR) 2002-77771

(51) Int. Cl. H01S 3/00

(52) U.S. Cl. 359/337.5

(57) ABSTRACT

Disclosed is a reflective optical amplifier for dispersion compensation that prevents undesired distortion caused by Rayleigh scattering generated from a DCF from being amplified in an optical fiber amplifier. More particularly, the reflective dispersion-compensation optical amplifier includes an amplifier having a first reflector to amplify, reflect and amplify the reflected optical signal; a dispersion compensator having a second reflector perform dispersion compensation of the amplified optical signal from the amplifier, reflect the dispersion-compensated optical signal using the second reflector, and perform a dispersion compensation on the reflected optical signal; and an optical path switching unit to transmit the input optical signal to the amplifier, transmit the output optical signal of the amplifier to the dispersion compensator, and generate an optical signal dispersion-compensated by the dispersion compensator.

### CLAIM OF PRIORITY

This application claims priority to an application entitled “REFLECTIVE DISPERSION-COMPENSATION OPTICAL AMPLIFIER,” filed in the Korean Intellectual Property Office on Dec. 9, 2002 and assigned Serial No. 2002-77771, the contents of which are hereby incorporated by reference.

### BACKGROUND OF THE INVENTION

1. Field of the Invention

The present invention relates to an optical amplifier for performing dispersion compensation in high-speed Wavelength Division Multiplexing (WDM) optical transmission. More particularly to a reflective dispersion-compensation optical amplifier for reducing the length of an Erbium-Doped Fiber Amplifier (EDFA) used for amplification and the length of a Dispersion Compensating Fiber (DCF) used for dispersion compensation.

2. Description of the Related Art

Recently, data transmission capacity for a WDM optical transmission system has been rapidly increasing, which follows the current trend of rapidly increasing use of data. As such data transmission capacity increases, a variety of methods for increasing the data transmission capacity have been investigated.

There are generally two methods for increasing data transmission capacity. The first method includes increasing the number of transmission channels, and the second method includes increasing the transfer rate for every channel. However, it is difficult to increase the number of transmission channels because available capacity for such transmission channels is limited. Therefore, the second method for increasing the transfer date for every channel is preferable. Provided that the transfer rate for every channel is over a Gigabit rate, a transmission signal on each channel is easily dispersed. Moreover, the transmission signal is greatly affected by a dispersion phenomenon such that a signal distortion is unavoidable.

A Dispersion Compensating Fiber (DCF) has been widely used to compensate for such dispersion. However, provided that the DCF is adapted for dispersion compensation in high-speed transmission of an optical signal, a significant power loss occurs from the optical signal such that the DCF needs a supplementary optical amplifier in such high-speed transmission.

FIG. 1 is a schematic diagram of a conventional optical amplifier for dispersion compensation (hereinafter referred to as a “dispersion compensation optical amplifier”).

Referring to FIG. 1, a conventional dispersion compensation optical amplifier includes a pump Laser Diode (LD) 12 for generating a pump optical signal to excite a state of an input optical signal, a WDM coupler 11 for combining the input optical signal with the pump optical signal generated from the pump LD 12, an erbium-doped amplifier 13 for amplifying an output optical signal of the WDM coupler 11, and a Dispersion Compensating Fiber (DCF) 14 for compensating dispersion of the amplified optical signal.

In particular, pump LD 12 generates a pump optical signal for exciting a quantum-mechanical state of a ground state. The pump optical signal is an optical signal of a specific wavelength to be amplified by erbium-doped amplifier 13.

Erbium-doped amplifier 13 commonly represents an Erbium-Doped Fiber Amplifier (EDFA). The EDFA adds Er³⁺, which is one of the rare earth ions, to a silica-based optical fiber and optically pumps the silica-based optical fiber having Er³⁺ at a level of 980 nm or 1480 nm. This combination is thereby adapted to amplify an optical signal having a bandwidth of 1.5 μm. The rare earth ion represents atoms each having 1 to 13 electrons in their 4 f orbit. Most rare earth ions have a charge of +3 when they are ionized. When electrons jump between 4 f-4 f orbits of such ions, these ions generate a fluorescent light within the wavelength range of visible and infrared rays. Representative examples of such ions are Er (Erbium) and Pr (Praseodymium), etc.

Emission of fluorescent light having a wavelength of 1.55 μm is induced when a weak input optical signal and pump optical signal are combined by WDM coupler 11 and the combined optical signal is applied to EDFA 13, the Er³⁺ ions contained in the EDFA 13 are excited by the pump optical signal and then shifted to a lower level by reducing the strength of the optical signal. The fluorescent light is combined with the optical signal and an enhanced optical signal further excites other ER³⁺ ions such that the optical signal is amplified by such induction of fluorescence emission.

DCF 14 is one WDM transmission element needed for optical transmission of more than 10 Gbps. It has a dispersion value opposite to that of a common optical fiber and is positioned on the center of a transmission path. Thus, it enables dispersion compensation of the optical fiber in high-speed transmission.

The method for performing dispersion compensation using such a DCF has disadvantages. For example, a DCF's properties are nonlinear due to its small DCF core and the cost of the DCF is higher than that of an optical fiber by about 1.5 times. Also, since the DCG has a high power loss, a supplementary optical amplifier for compensating such power loss is generally employed. The power loss changes with temperature.

In the meantime, a reflective optical amplifier for dispersion compensation has been proposed to improve the common optical amplifier adapted for dispersion compensation.

FIG. 2 is a schematic diagram of a conventional reflective optical amplifier for dispersion compensation.

The reflective optical amplifier shown in FIG. 2 is adapted to shorten the lengths of the DCF and EDFA, thereby reducing the costs of the DCF and EDFA. The reflective optical amplifier includes a three-port circulator 21 and a Faraday Rotator Mirror (FRM) 26 for reflectively transmitting an input optical signal 201.

In particular, input optical signal 201 enters a first port 1 of three-port circulator 21, and then enters WDM coupler 22 via a second port 2. WDM coupler 22 couples input optical signal 202 with a pump optical signal received from a pump Laser Diode (LD) 23, and then transmits the coupled optical signal to an EDFA 24. The pump optical signal is adapted to excite the state of input optical signal 202.

EDFA 24 amplifies the optical signal received from WDM coupler 22. DCF 25 receives the amplified optical signal and performs a dispersion compensation operation on the received optical signal. FRM 26 receives the dispersion-compensated optical signal and then reflects it.

The optical signal reflected from FRM 26 is dispersion-compensated by the DCF 25 and is optically amplified by EDFA 24, and then outputted via WDM coupler 22. Optical signal 203 from WDM coupler 22 is generated as optical signal 204 via second and third ports 2-3.

Comparing the reflective optical amplifier for dispersion compensation shown in FIG. 2 with the conventional optical amplifier for dispersion compensation shown in FIG. 1, the reflective optical amplifier reduces the lengths of the DCF and the erbium-doped amplifier, such as an EDFA, by 50% compared to the conventional optical amplifier shown in FIG. 1. This is due to the use of a reflection phenomenon to perform dispersion compensation. Moreover, provided that the length of EDFA 13 in FIG. 1 is L₁₋₁ and the length of DCF 14 is L₁₋₂, the length L₂₋₁ of EDFA 24 in FIG. 2 becomes L₂₋₁/2 and the length L₂₋₂ of DCF 25 in FIG. 2 becomes L₁₋₂/2. Consequently, production costs of are greatly reduced and the pump power level is reduced in proportion to the reduced length of the amplifier.

However, when an optical signal is (1) amplified, (2) firstly dispersion-compensated, (3) reflected, (4) secondly dispersion-compensated, and (4) finally amplified, an intensive optical signal generated from an optical fiber amplifier enters the DCF. This unavoidably causes Rayleigh scattering. Hence, the optical signal is affected by Rayleigh scattering and an undesired distortion is caused and is also amplified such that transmission quality is greatly degraded.

In particular, provided that the amplification factor (i.e., Input/Output) is ‘α’ after one amplification and such a value caused by the Rayleigh scattering is ‘β’ after one dispersion compensation, an input signal ‘I’ becomes ‘Iα’ by one amplification and becomes ‘Iα+2β’ by two dispersion compensations, and finally becomes ‘(Iα+2β)α’ by the last amplification. Similarly, a distortion value 2β caused by the Rayleigh scattering in the reflective optical amplifier shown in FIG. 2 is higher than that of the conventional optical amplifier shown in FIG. 1 by ‘α’ times.

### SUMMARY OF THE INVENTION

Therefore, the present invention reduces or overcomes many of the above problems.

One object of the present invention is to provide a reflective dispersion-compensation optical amplifier for preventing a distortion value caused by Rayleigh scattering generated in a DCF from being amplified in an optical fiber amplifier and maintaining the advantages of a reflective amplifier.

In accordance with the principles of the present invention, a reflective dispersion-compensation optical amplifier is provided including an amplifier having a first reflector for (1) amplifying an input optical signal, (2) reflecting the amplified optical signal, and (3) amplifying the reflected optical signal; a dispersion compensator having a second reflector for (1) performing a dispersion compensation of the amplified optical signal generated from the amplifier, (2) reflecting the dispersion-compensated optical signal, (3) and performing a dispersion compensation of the reflected optical signal; and an optical path switching unit for (1) transmitting the input optical signal to the amplifier, (2) transmitting the output optical signal of the amplifier to the dispersion compensator, and (3) generating an optical signal dispersion-compensated by the dispersion compensator.

### BRIEF DESCRIPTION OF THE DRAWINGS

The present invention will be more clearly understood from the following detailed description taken in conjunction with the accompanying drawings, in which:

FIG. 1 is a schematic diagram of a conventional optical amplifier for dispersion compensation;

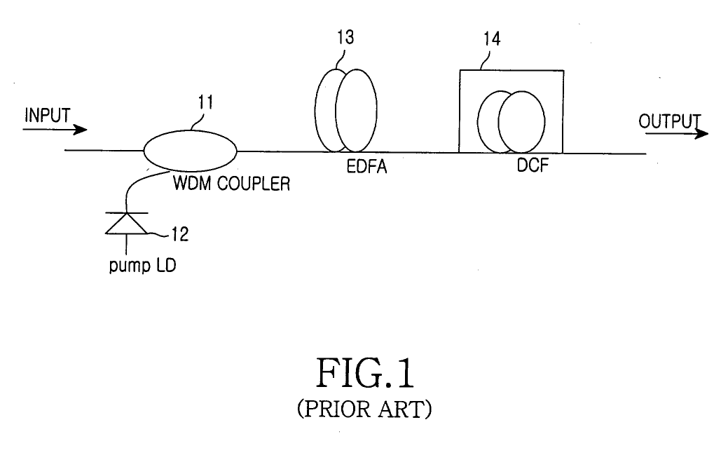

FIG. 2 is a schematic diagram of a conventional reflective optical amplifier for dispersion compensation;

FIG. 3 is a schematic diagram of a reflective optical amplifier for dispersion compensation in accordance with a preferred embodiment of the present invention;

FIG. 4 is a detailed block diagram of an amplifier used for a reflective optical amplifier for dispersion compensation in accordance with a preferred embodiment of the present invention; and

FIG. 5 is a detailed block diagram of a dispersion compensator used for a reflective optical amplifier for dispersion compensation in accordance with a preferred embodiment of the present invention.

### DETAILED DESCRIPTION OF THE PREFERRED EMBODIMENTS

In the following description of the present invention, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, it will be recognized that certain aspects of the figures are simplified for explanation purposes and that the full system environment for the invention will comprise many known functions and configurations all of which need not be shown here. In the drawings, the same or similar elements are denoted by the same reference numerals even though they are depicted in different drawings.

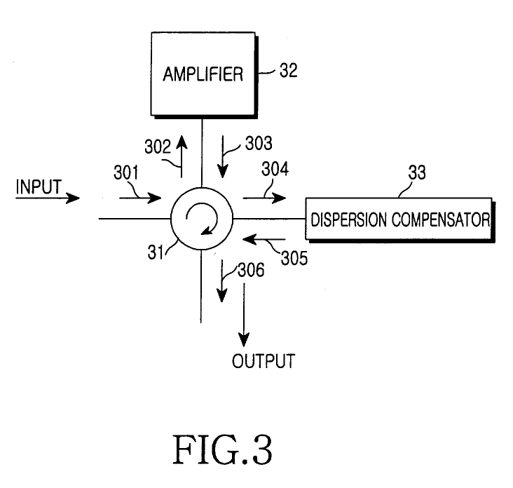

FIG. 3 is a schematic diagram of a reflective optical amplifier for dispersion compensation in accordance with a preferred embodiment of the present invention.

Referring to FIG. 3, the reflective optical amplifier for dispersion compensator includes an amplifier 32 for amplifying an input optical signal, a dispersion compensator 33 for performing a dispersion compensation of the amplified optical signal, and a circulator 31 for transmitting the input optical signal to the amplifier 32, transmitting the amplified optical signal to the dispersion compensator 33, and transmitting the dispersion-compensated optical signal generated from the dispersion compensator 33 to an output terminal.

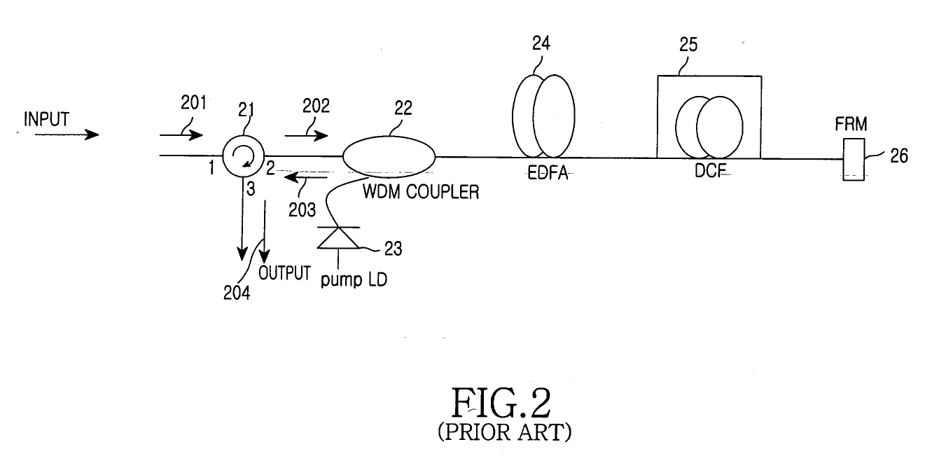

Importantly, the reflective optical amplifier according to the present invention includes two reflection units to obviate a problem of the conventional reflective optical amplifier shown in FIG. 2. Specifically, the amplifier adapts one of the two reflection units to perform an amplification operation and the other to perform a dispersion compensation operation.

Referring to FIG. 3, an input optical signal 301 is transmitted to an input optical signal 302 of amplifier 32 via a four-port circulator, an optical signal 303 amplified by amplifier 32 is transmitted to an input optical signal 304 of dispersion compensator 33 via a four-port circulator 31, and an optical signal 305 dispersion-compensated by dispersion compensator 33 is generated as an output optical signal 306 via four-port circulator 31.

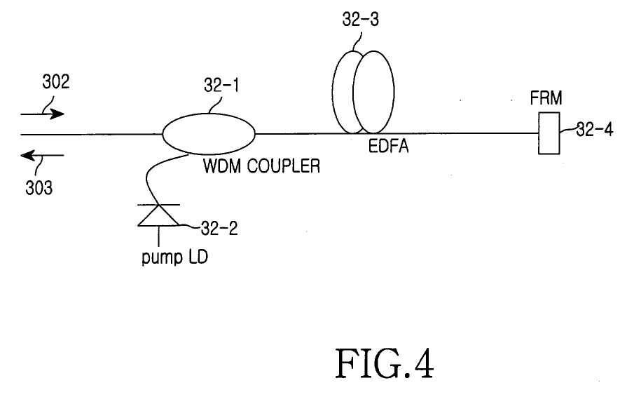

A detailed diagram of amplifier 32 is shown in FIG. 4. FIG. 4 is a detailed block diagram of the amplifier 32 used for a reflective optical amplifier for dispersion compensation in accordance with a preferred embodiment of the present invention.

Referring to FIG. 4, amplifier 32 includes a pump LD 32-2 for generating a pump optical signal to excite a state of input optical signal 302, a WDM coupler 32-1 for combining input optical signal 302 with the pump optical signal generated from pump LD 32-2, an EDFA 32-3 for amplifying an output optical signal of WDM coupler 32-1, and a Faraday Rotator Mirror (FRM) 32-4 for reflecting the amplified optical signal, optically amplifying it using the EDFA 32-3 and generating an output optical signal 303.

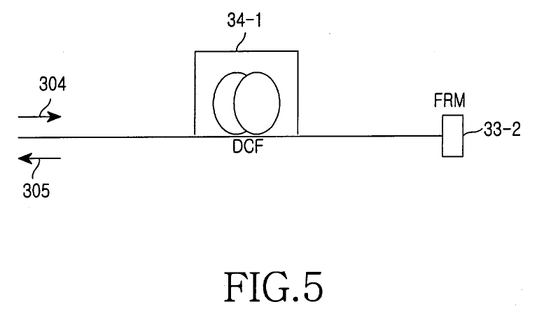

Dispersion compensator 33 shown in FIG. 3 is shown in FIG. 5 in more detail. FIG. 5 is a detailed block diagram of the dispersion compensator 33 used for a reflective optical amplifier for dispersion compensation in accordance with a preferred embodiment of the present invention.

Referring to FIG. 5, dispersion compensator 33 includes a DCF 33-1 for compensating an optical fiber's dispersion of an amplified input optical signal 304, and a FRM 33-2 for reflecting a dispersion-compensated optical signal, performing a dispersion compensation of the reflected optical signal using a DCF 33-1, and generating a dispersion-compensated optical signal 305.

In particular, provided that FRMs 32-4 and 33-2 serving as a reflector are respectively used for amplifier 32 and dispersion compensator 33, a Polarization Mode Dispersion (PMD) generated from EDFA 32-3 or DCF 33-1 is compensated. The F RM makes the polarization of input optical signal be orthogonal to that of the reflected optical signal. A progressing speed in the X-axis direction of a fiber is different from that in the Y-axis direction of the fiber when an optical signal passes through the fiber, because of structural limitations of the fiber or external influences. As a result, there is a phase difference between the progressing speeds in the directions of X-axis and Y-axis because of a relative time delay, thereby causing PMD. When using the FRM, an optical signal having a polarization of 900 in comparison with an input optical signal is reflected, and travels in the reverse direction along the same path as the input optical signal such that the phase difference caused by such a time delay is compensated. Therefore, an arbitrary polarization state of the input optical signal is maintained such that PMD is compensated. However, it is noted that the reflector used in the present invention is not limited to such a FRM and is applicable to similar ones.

In particular, the reflective optical amplifier shown in FIG. 3 transmits an input optical signal 302 entering a first port of circulator 31 to amplifier 32 connected to a second port of circulator 31.

Referring to FIG. 4, WDM coupler 32-1 of amplifier 32 combines input optical signal 302 generated from the second port of circulator 31 with a pump optical signal generated from pump LD 32-2, and transmits the combined signal to EDFA 32-3. FRM 32-4 is connected to an output terminal of EDFA 32-3 such that it again reflects the amplified optical signal generated from EDFA 32-3. FRM 32-3 makes the polarization of such an input optical signal orthogonal to that of the reflected optical signal. The reflected optical signal is amplified by EDFA 32-3, returns to the second port of circulator 31 to become optical signal 303, and enters dispersion compensator 33 connected to a third port of circulator 31.

Optical signal 304 entering DCF 33-1 connected to the third port of circulator 31 is dispersion-compensated by DCF 33-1, and is then reflected from FRM 33-2 connected to an output terminal of DCF 33-1. The reflected optical signal again passes through DCF 33-1 to compensate its own dispersion such that it is changed to an input optical signal 305 of the third port of circulator 31, and finally it becomes an output optical signal of a fourth port of circulator 31.

As noted above, the reflective optical amplifier for individually operating Input/Output (I/O) terminals, the amplifier, and the dispersion compensator through the use of the four-port circulator allows an optical signal to pass the EDFA twice. Thus, the length of the EDFA and the power level of the pump LD are reduced. In addition, because of the FRM's characteristics of making the polarization of an input optical signal orthogonal to that of a reflected optical signal, an arbitrary polarization state of input optical signal 302 entering a second port of the circulator is maintained such that PMD of the EDFA is compensated.

In this manner, an optical signal passes the DCF twice such that the length of the DCF is reduced by 50% compared to the conventional optical amplifier. An arbitrary polarization state of an input optical signal 304 entering a third port of the circulator is maintained because the optical signal is reflected from the FRM, and PMD caused by the DCF is compensated. Further, undesired distortion caused by Rayleigh scattering of the DCF is not applied to the optical amplifier because of the characteristics of the circulator. Consequently, the reflective optical amplifier for dispersion compensation according to the present invention has transmission characteristics superior to those of the conventional reflective optical amplifier.

In short, as one skilled in the art will recognize from the above description, the present invention prevents an undesired distortion caused by Rayleigh scattering generated from a DCF from being amplified by an optical amplifier, thereby achieving superior transmission characteristics and maintaining advantages of a conventional reflective amplifier. Moreover, in accordance with the principles of the present invention, (1) the length of an EDFA and the length of a DCF are respectively reduced by 50% compared to a conventional reflective optical amplifier, (2) the power level of pump LD of the EDFA is also reduced, (3) an arbitrary polarization state of an input optical signal is maintained using FRM, and (4) PMD is also compensated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A reflective dispersion-compensation optical amplifier comprising:
an amplifier configured to amplify, reflect and re-amplify an input optical signal;
a dispersion compensator configured to perform dispersion compensation on the re-amplified optical signal from the amplifier, reflect the dispersion-compensated optical signal and perform dispersion compensation of the reflected optical signal; and
an optical path switching unit coupled to the amplifier and the dispersion compensator, to enable a transmission path there between and provide an output.

2. The reflective dispersion-compensation optical amplifier as set forth in claim 1, wherein the optical path switching unit includes transmitting the input optical signal to the amplifier, transmitting the output optical signal of the amplifier to the dispersion compensator, and generating an optical signal dispersion-compensated by the dispersion compensator.

3. The reflective dispersion-compensation optical amplifier as set forth in claim 1, wherein the amplifier includes first reflector configured to reflect the amplified input optical signal.

4. The reflective dispersion-compensation optical amplifier as set forth in claim 3, wherein the dispersion compensator includes a second reflector configured to reflect the dispersion-compensated optical signal.

5. The reflective dispersion-compensation optical amplifier as set forth in claim 4, wherein the amplifier includes:
a pump optical signal generator to generate a pump optical signal to excite a state of the input optical signal;
a WDM coupler to combine the input optical signal with the pump optical signal;
an erbium-doped amplifier to amplify an output optical signal of the WDM coupler and amplify an optical signal reflected by the first reflector; and
the first reflector to reflect the amplified optical signal received from the erbium-doped amplifier and transmit the reflected optical signal to the erbium-doped amplifier.

6. The reflective dispersion-compensation optical amplifier as set forth in claim 4, wherein the dispersion compensator includes:
a dispersion compensation optical fiber for compensating an optical fiber's dispersion of the amplified optical signal received from the amplifier, and performing a dispersion compensation of an optical signal reflected by the second reflector; and
the second reflector to reflect the dispersion-compensated optical signal generated from the dispersion compensation optical fiber and transmit the reflected dispersion-compensated optical signal to the dispersion compensation optical fiber.

7. The reflective dispersion-compensation optical amplifier as set forth in claim 1, wherein the optical path switching unit is a circulator for connecting the amplifier and the dispersion compensator, and making the amplifier be not affected by Rayleigh scattering generated in the dispersion compensator.

8. The reflective dispersion-compensation optical amplifier as set forth in claim 5, wherein the erbium-doped amplifier is an EDFA.

9. The reflective dispersion-compensation optical amplifier as set forth in claim 5, wherein the first reflector is an FRM.

10. The reflective dispersion-compensation optical amplifier as set forth in claim 6, wherein the second reflector is an FRM.

11. The reflective dispersion-compensation optical amplifier as set forth in claim 6, wherein the dispersion compensation optical fiber has a dispersion value opposite to that of an optical fiber used for transmission in order to perform a dispersion compensation of the optical signal.
